(19) United States
(12) Patent Application Publication
(10) Pub. No.: US 2022/0145158 A1
(43) Pub. Date: May 12, 2022

(54) STABLE MAGNETIC DRILLING MUD AND METHOD

(71) Applicant: KING ABDULLAH UNIVERSITY OF SCIENCE AND TECHNOLOGY, Thuwal (SA)

(72) Inventors: Juan Carlos SANTAMARINA, Thuwal (SA); Qi LIU, Thuwal (SA); Anant GHUMARE, Thuwal (SA)

(21) Appl. No.: 17/436,139

(22) PCT Filed: Feb. 14, 2020
(86) PCT No.: PCT/IB2020/051276

§ 371 Date: Sep. 3, 2021

Related U.S. Application Data
(60) Provisional application No. 62/842,561, filed on May 3, 2019.
(60) Provisional application No. 62/835,749, filed on Apr. 18, 2019.

(51) Int. Cl. C09K 8/16; C09K 8/22; H01F 1/34; E21B 47/002

(52) U.S. Cl. CPC C09K 8/16; E21B 47/0025; H01F 1/344; C09K 8/22

(57) ABSTRACT

A magnetic drilling mud for use in a well, the magnetic drilling mud including water; bentonite; magnetic micro-particles; and an anionic surfactant that prevents separation of the bentonite and the magnetic micro-particles in the water. The magnetic micro-particles have a diameter less than 100 μm.

### CROSS-REFERENCE TO RELATED APPLICATIONS

This application claims priority to U.S. Provisional Patent Application No. 62/835,749, filed on Apr. 18, 2019, entitled “MAGNETIC WATER BASED DRILLING MUD,” and U.S. Provisional Patent Application No. 62/842,561, filed on May 3, 2019, entitled “MAGNETIC WATER BASED DRILLING MUD,” the disclosures of which are incorporated herein by reference in their entirety.

### BACKGROUND

### Technical Field

Embodiments of the subject matter disclosed herein generally relate to a drilling mud used to aid the drilling of boreholes into the earth, and more particularly, to a magnetic drilling mud having a composition that is stable, economically viable, and suitable for wellbore monitoring.

### Discussion of the Background

During drilling a wellbore for oil and gas exploration, a drilling mud is used for multiple purposes. For example, as the drill bit 102 of a drilling system 100 illustrated in FIG. 1 is advancing inside the well 104, cuttings 106 are accumulated around the drill bit 102 unless they are flushed out of the well. The drilling mud 110 is used to remove the cuttings 106 from the well 104 by pumping, with a pump 112, the drilling mud 110 through a conduit 114 placed inside the well 104 and returning the contaminated drilling mud through the annular space 116 between the conduit 114 and the well 104, to a filtering facility 118. At the surface, the drilling mud 110 is separated in the filtering facility 118 from the cuttings 106 and recirculated back to the drill bit 102, as also illustrated by FIG. 1. The pump 112 ensures the flow of the drilling mud as desired in this closed loop circuit.

The drilling mud is also used to control the formation pressure around the well. Note that one or more formations 120 may exist around the well that hold oil 122, and a pore water pressure above the formation may be larger than the wellbore pressure, so that the oil may have a pressure larger than the pressure inside the well. Thus, the drilling mud may be pressurized by the pump 112 to be substantially equal to the oil pressure or lower, so that a flow of the pore fluid into the well can be controlled. Also, by controlling the drilling mud pressure, it is possible to maintain the integrity of the well as the increased formation pressure may damage the walls of the well if that formation pressure is not balanced by the drilling mud pressure.

The drilling mud may also be used to seal permeable formations or channels existing in the formation 120 during drilling. The drilling mud may also be used to reduce a friction between the drill pipe 114 or casing and the wellbore 104, cools and cleans the drill bit 102, coats the formation 120 with a thin, low-permeability filter cake, maintains wellbore stability, and minimizes formation damage.

In some applications, it is desired to be able to trace the movement of the drilling mud through the formation 120. For these applications, the presence of a tracer material in the drilling mud allows the operator of the well to measure the fluid movement around the borehole, which is critical for the identification of several important events, such as, e.g., lost circulation, mudcake formation, and cement displacement. The tracer material is typically added to the composition of the drilling mud.

Note that a drilling mud may have various compositions, e.g., can be water based, oil based, synthetic based, may include various chemicals such as polymers, foaming agents, clays, depending on the intended purpose of the drilling mud.

Radioactive tracers have been used for decades to determine the flow rate and flow profiles, to evaluate completion problems and treatment effectiveness etc. Recently, magnetic particles have been used as a high-magnetic susceptibility tracer, as discussed in [1] or as a contrast agent in NMR, as discussed in [2] and [3] for formation characterization.

One such tracer is a magnetic bentonite material. Magnetic bentonite can be prepared with either chemical synthetic methods or by adding iron oxide particles directly into the bentonite slurry. However, the existing methods generate a drilling mud that is not stable, i.e., the materials in the mud precipitate, or the drilling mud is expensive.

Thus, there is a need for a new drilling mud and associated manufacturing method that overcomes the above noted problems.

### BRIEF SUMMARY OF THE INVENTION

According to an embodiment, there is a magnetic drilling mud for use in a well and the magnetic drilling mud includes water, bentonite, magnetic micro-particles, and an anionic surfactant that prevents separation of the bentonite and the magnetic micro-particles in the water. The magnetic micro-particles have a diameter less than 100 μm.

According to another embodiment, there is a method for making a magnetic drilling mud for use in a well, and the method includes adding bentonite to water to obtain a mixture, aging the mixture by exposing the mixture to a temperature larger than a room temperature, adding magnetic micro-particles to the mixture, and adding an anionic surfactant that prevents separation of the bentonite and the magnetic micro-particles in the water. The magnetic micro-particles have a diameter less than 100 μm, and the anionic surfactant has a molecular concentration smaller than or equal to a critical micelle concentration of the anionic surfactant.

According to yet another embodiment, there is a method for imagining a wellbore, and the method includes pumping down a magnetic drilling mud into a well, applying a pressure to the magnetic drilling mud to enter into fractures into a formation, moving a magnetic probe inside the well, to record a magnetic field generated by the magnetic drilling mud, and generating an image of the well based on recorded data indicative of the magnetic field generated by the magnetic drilling mud. The magnetic drilling mud includes water, bentonite, magnetic micro-particles, and an anionic surfactant that prevents separation of the bentonite and the magnetic micro-particles in the water, and the magnetic micro-particles have a diameter less than 100 μm.

### BRIEF DESCRIPTION OF THE DRAWINGS

For a more complete understanding of the present invention, reference is now made to the following descriptions taken in conjunction with the accompanying drawings, in which:

FIG. 1 shows a traditional oil exploration system that uses a drilling mud;

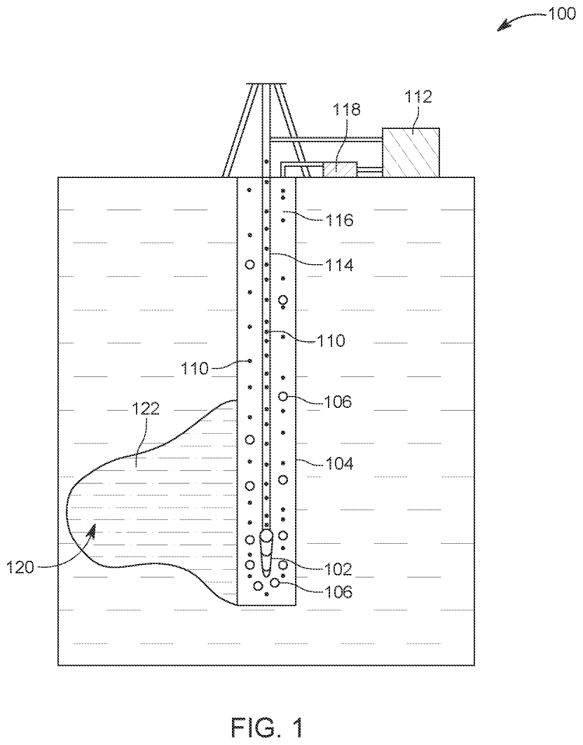

FIG. 2 is a flowchart of a method for making a magnetic drilling mud that is inexpensive and stable;

FIG. 3 illustrates various surfactants that may be added to the magnetic drilling mud;

FIG. 4 illustrates an ion composition of bentonite;

FIG. 5 illustrates the terminal velocity of the ferromagnetic particles in the drilling mud as a function of a radius of these particles;

FIGS. 6A and 6B illustrate the stability in time of drilling muds having various surfactants;

FIGS. 7A and 7B illustrate the stability in time of a magnetic drilling mud having different amounts of an anionic surfactant;

FIG. 8A illustrates the apparent viscosity versus the shear rate of various suspensions based on 2% bentonite and FIG. 8B illustrates the apparent viscosity versus the shear rate of similar suspensions but having 3% bentonite;

FIG. 9 illustrates the influence of temperature on the viscosity of the magnetic drilling mud;

FIG. 10A illustrates the magnetic moment of the magnetic drilling mud (hysteresis curves of the magnetic drilling mud) and FIG. 10B illustrates the saturation magnetization and the residual magnetization of the magnetic drilling muds with different Fe₃O₄ mass concentration;

FIG. 11 illustrates a system for imagining a well based on a magnetic drilling mud; and

FIG. 12 is a flowchart of a method for imagining the well with the magnetic drilling mud.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a stable magnetic drilling mud that includes sodium dodecyl sulfate (SDS) as a stabilizing surfactant. However, the embodiments to be discussed next are not limited to such a surfactant, but may use other anionic surfactants.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, an economical and stable magnetic drilling mud for wellbore monitoring purpose is introduced. The novel magnetic drilling mud includes inexpensive micro-size Fe₃O₄ particles having a diameter of about d=100 μm, that are used to magnetize a bentonite slurry. In one application, the diameter of the micro-particles is about 50 μm. A selected anionic surfactant (e.g., SDS) is added to stabilize the Fe₃O₄-bentonite suspension. The type of surfactant and its concentration are discussed later. The suspension's stability, rheological properties, and magnetic hysteresis, which are discussed later in more detail, indicate that this novel drilling mud is stable, economic, and magnetic.

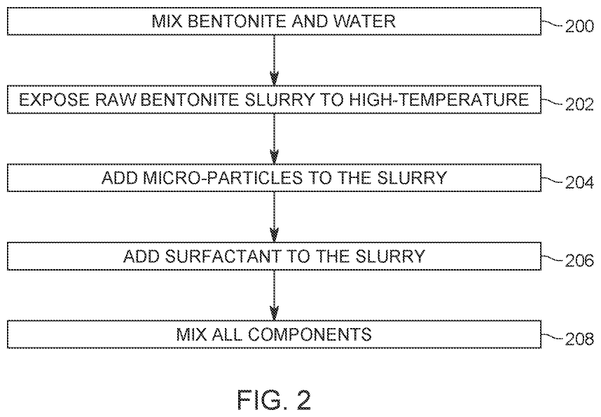

A method for forming the novel magnetic drilling mud is now discussed with regard to FIG. 2. In step 200, bentonite powder was mixed with deionized water to obtain a bentonite slurry. In one application, the mass of the bentonite powder was substantially 2% of the total mass of the bentonite slurry. In this application, the term “substantially” is defined as including a range of +/−15% of a value that is characterized by this term. A mass larger than 2% for the bentonite slurry may be used. In step 200, the raw bentonite slurry is prepared by agitating the bentonite powder and the deionized water for 30 minutes in a constant speed blender. Then, in step 202, the raw bentonite slurry undergoes a high-temperature aging, for example, for about 20 hours at 85° C. to assure the sufficient dispersion and hydration of the bentonite platelets.

Fe₃O₄ micro-particles (not nano- or milli-particles) that are magnetic are added in step 204 and one or more surfactants are added in step 206 into the aged bentonite slurry and all these elements are mixed in step 208 for about 30 minutes in a stand mixer. Step 204 may be performed with other magnetic micro-particles, for example, NbO, NbO₂, NiO, Ni₂O₃, and Mn₂O₃. The amount of the micro-particles added in step 204 is between 0.1 and 10% of the total mass of the bentonite slurry. The surfactant added in step 206 is SDS. The Fe₃O₄ micro-particles used in this embodiment have an average diameter around 50 μm and the bentonite used in step 200 is in powder form.

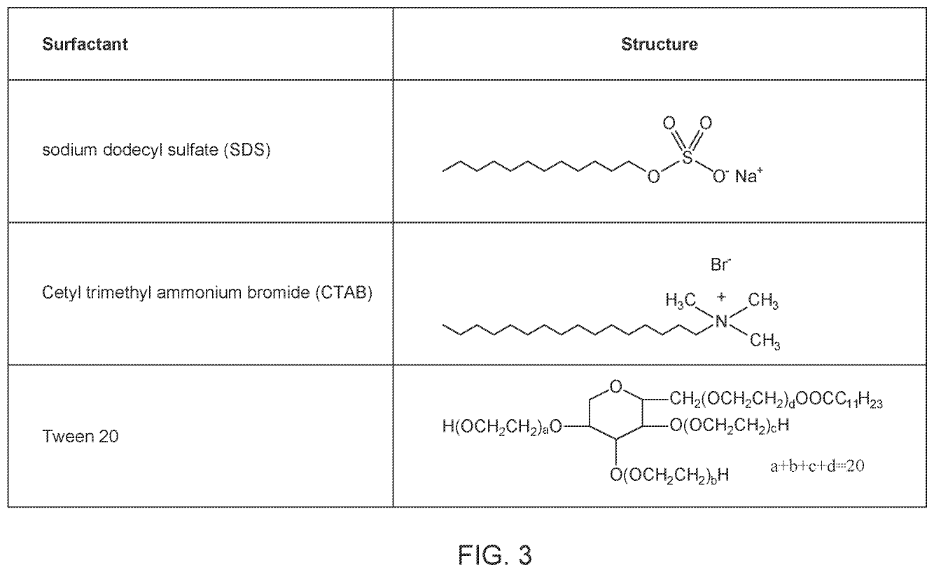

In addition to the SDS surfactant used in step 206, two more surfactants were studied: cetyltrimethyl ammonium bromide (CTAB), and Tween-20 (which is a polyoxyethylene sorbitol ester that belongs to the polysorbate family; it is a nonionic detergent having a molecular weight of 1,225 daltons, assuming 20 ethylene oxide units, 1 sorbitol, and 1 lauric acid as the primary fatty acid). FIG. 3 illustrates the chemical structure of the three surfactants SDS, CTAB, and Tween-20 used to generate three different magnetic bentonite slurries. The magnetic bentonite slurries manufactured based on the method of FIG. 2, with the surfactants illustrated in FIG. 3 were studied and compared as now discussed.

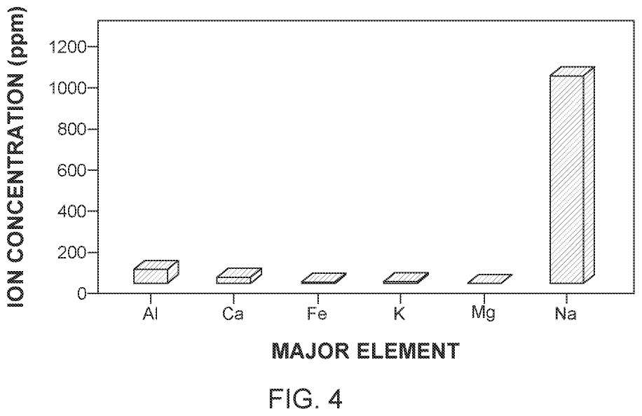

An X-ray diffraction (XRD) analysis was performed in order to determine the chemical composition of the bentonite powder. Samples of the bentonite powder were passed through 200 mesh size sieves. The bentonite basically consists of sodium montmorillonite (Na,Ca)_{0.33}(Al, Mg)₂(Si₄O₁₀)(OH)₂ₙH₂O) and it was found that the 28 peaks are at 7.511, 28.121, 35.101, 48.021, 52.311 and 76.201. A spectrometer was used to determine the cations available in the bentonite and FIG. 4 shows that the sodium cation is dominant among all cations while trace amounts of other cations can also be found in the bentonite powder.

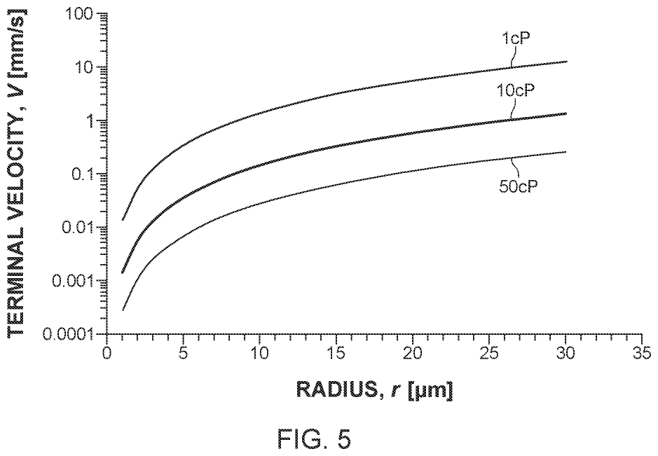

Long-term stability of the drilling mud is one of the requirements for a successful mud. Thus, this characteristic of the various magnetic drilling muds manufactured as noted above has been investigated. The Fe₃O₄ micro-particle is inherently instable in a bentonite slurry due to the high density of the iron oxide (ρ=5.17 g/cm³). In addition, the existing magnetic muds use a high-cost sub-micron magnetic particles to achieve the stability. In this regard, FIG. 5 shows the effects of the magnetic particle size and fluid viscosity on the terminal velocity V_{T} of the Fe₃O₄ particles, which is calculated using the expression:

$${v}_{T} = \frac{{d}^{2} ( {ρ}_{s} - {ρ}_{f} )}{18 μ} ,$$

where ρₛ and ρᵣ are the density of the solid particle and the fluid respectively, d is the diameter of the particles, and μ is the viscosity of the fluid.

It is noted that the micro-size particles (i.e., particles having a size in the micrometer range) have a much higher terminal velocity compared to the sub-micro-size particles (i.e., nano-particles having a size less than 1 micrometer) even at a high viscosity. In this regard, FIG. 5 shows the dependency of the terminal velocity over the radius of the particles for different viscosities, which are measured in centiPoise, cP. A high terminal velocity leads to a rapid separation of the particles in the liquid phase in the drilling mud. For this reason, the existing magnetic bentonite-based drilling muds use the high-cost sub-micron magnetic particles to achieve the required stability. Alternatively, the inventors have selected an anionic surfactant to assist the process of suspending the Fe₃O₄ micro-particles in the bentonite slurry. An anionic surfactant is characterized by a negatively charged hydrophilic polar group. As noted above, the surfactants that have been tested include: anionic surfactant SDS, cationic surfactant CTAB, and nonionic Tween 20, which are illustrated in FIG. 3.

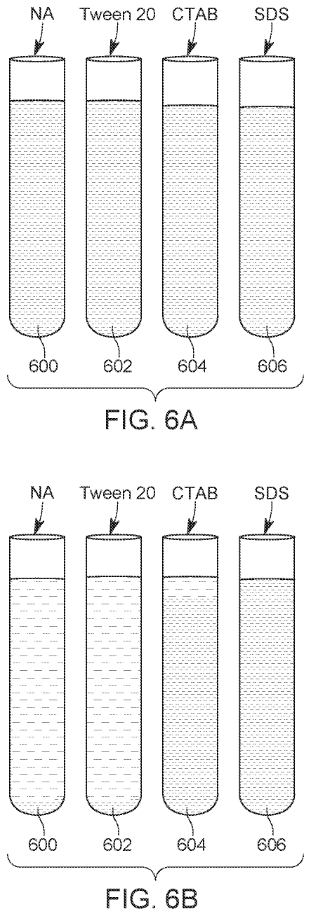

Based on these observations, the stability of various suspensions stabilized with the three types of surfactants having a molar concentration of 8 mM, and including 5% by mass Fe₃O₄ particles, and 2% by mass bentonite, have been studied as illustrated in FIGS. 6A and 6B. Note that M stands for the molar concentration, also called molarity, amount concentration or substance concentration, and it is a measure of the concentration of a chemical species, in particular of a solute in a solution, in terms of amount of substance per unit volume of solution. In chemistry, the most commonly used unit for molarity is the number of moles per liter, having the unit symbol mol/L. A solution with a concentration of 1 mol/L is said to be 1 molar, commonly designated as 1 M.

FIG. 6A shows a first drilling mud 600 having no surfactant, a second drilling mud 602 having Tween-20 as the surfactant, a third drilling mud 604 having CTAB as the surfactant, and a fourth drilling mud 606 having SDS as the surfactant. The sample 600 with no surfactant shows a very poor stability. The nonionic surfactant Tween-20 in the sample 602 does not show a significant contribution to the stability of suspension when compared with the sample 600. However, both the cationic surfactant CTAB in sample 604 and the anionic surfactant SDS in sample 606 improve the stability of the suspension, as shown in FIG. 6B. FIG. 6B shows the status of the samples after 2 hours settling time. The suspension 604 stabilized by the CTAB starts showing separation between the iron oxide particles and the bentonite. However, the suspension 606 stabilized by the SDS has been found to show insignificant separation after 2 hours. The sample 600 shows total separation while the sample 602 shows near total separation. The results illustrated in FIGS. 6A and 6B show the advantage of using the SDS as the surfactant in the drilling mud, in terms of its stability.

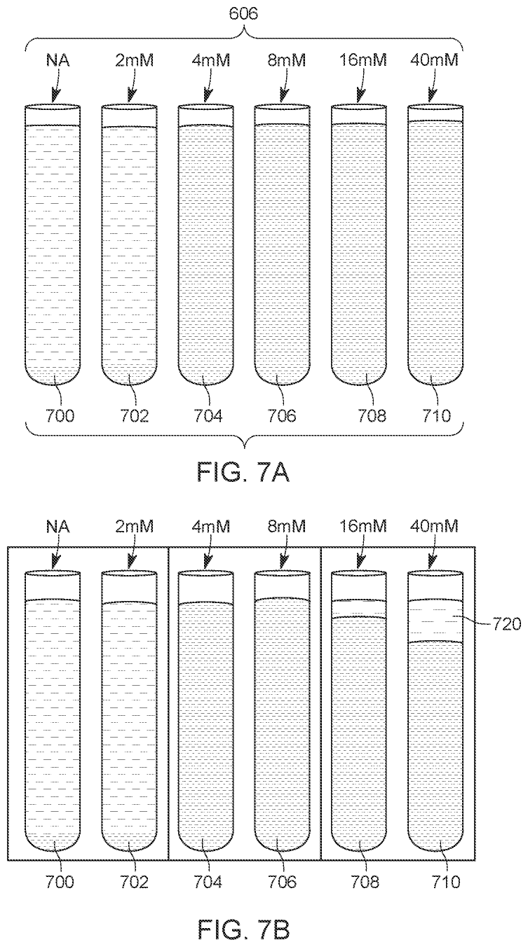

The influence of the concentration of the SDS on the suspension's stability has also been investigated. In this regard, FIG. 7A shows plural samples 700 to 710 of the SDS-based magnetic drilling mud 606 having Fe₃O₄ particles, SDS and bentonite. The SDS has various concentrations in the samples while the amount of magnetic particles and bentonite is kept constant. The concentration C_{SDS} of the SDS surfactant is shown on top of each sample as a molar concentration. FIG. 7B shows the same samples after 24 h. It is noted that at low concentrations (C_{SDS}<4 mM), a clear separation between the Fe₃O₄ particles and the bentonite is observed for samples 700 and 702. A stable suspension can be formed with C_{SDS}=4˜8 mM, as indicated by samples 704 and 706. A high concentration of SDS (C_{SDS}>16 mM) leads to co-sedimentation of the bentonite and iron oxide particles, as shown in FIG. 7B for the samples 708 and 710, as indicated by the completely clear upper layer 720. The same samples were tested under different temperatures (20° C. to 85° C.). A stable suspension is observed over the entire temperature range for the samples 704 and 706 having the SDS concentration C_{SDS}=4˜8 mM.

This concentration range is close to the critical micelle concentration (CMC) of the SDS surfactant (8.2 mM at 25° C.). Note that in colloidal and surface chemistry, the critical micelle concentration (CMC) is defined as the concentration of surfactants above which micelles form and all additional surfactants added to the system go to micelles. Thus, in one embodiment, the molar concentration of the anionic surfactant of the magnetic drilling mud is selected to be the same as the critical micelle concentration of that surfactant. In another embodiment, the molar concentration of the anionic surfactant of the magnetic drilling mud is selected to be in a range smaller than the critical micelle concentration. In still another embodiment, the molar concentration of the anionic surfactant of the magnetic drilling mud is selected to be between half the CMC and one CMC. Note that a high bentonite mass concentration can improve the stability of the suspension due to its large viscosity.

Rheology is another property of a drilling fluid. The rheology is the science of deformation and flow within a material. The viscosity of the bentonite suspension is sensitive to the presence of additives and contaminants. The influence of the Fe₃O₄ micro-particles and the SDS surfactant on the rheological behaviors of the bentonite slurries under different temperatures has been investigated.

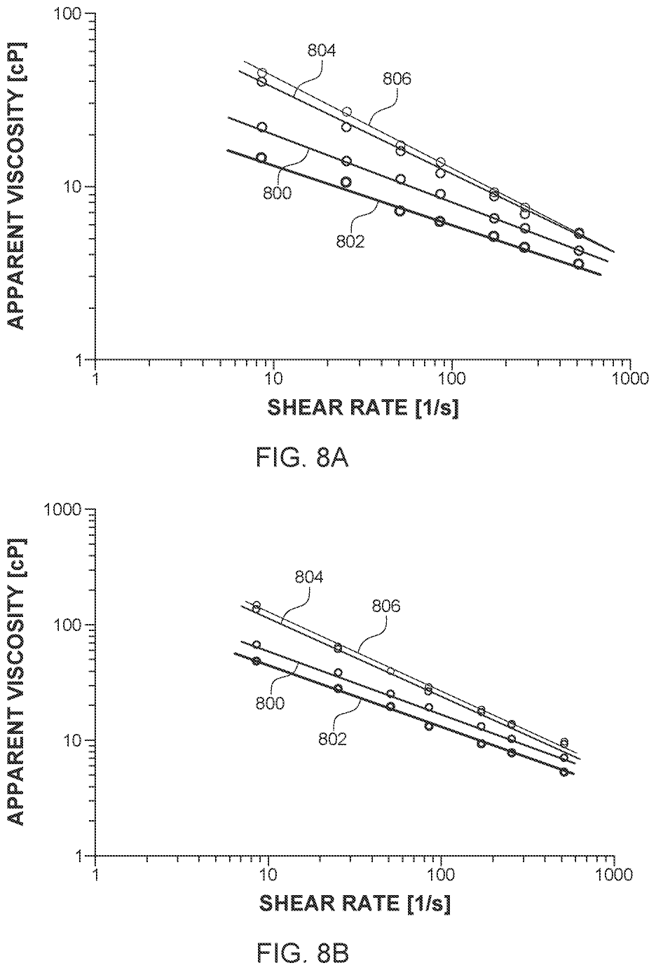

FIGS. 8A and 8B illustrate the rheological behavior of the bentonite-Fe₃O₄-SDS system. FIG. 8A shows the apparent viscosity versus the shear rate of various suspensions based on 2% bentonite and FIG. 8B shows the apparent viscosity versus the shear rate of similar suspensions, but having 3% bentonite. Line 800 illustrates the raw bentonite, line 802 illustrates the bentonite slurry having 1% Fe₃O₄ (no SDS is present), line 804 illustrates the bentonite-Fe₃O₄-SDS system with 1% Fe₃O₄ and 8 mM SDS, and line 806 illustrates the bentonite-Fe₃O₄-SDS system with 5% Fe₃O₄ and 8 mM SDS. Samples based on the 3% bentonite suspensions (those shown in FIG. 8B) show a much higher viscosity compared to the 2% suspensions (those shown in FIG. 8A) due to the high-viscosity of the bentonite. All samples show a shear-thinning behavior which is consistent with the rheology of the raw bentonite suspension.

The addition of the Fe₃O₄ particles and the SDS surfactant has a similar influence on the viscosity of the 2% and 3% bentonite slurries. With the addition of 1% Fe₃O₄ particles, a significant decrease in the viscosity of the suspension (line 802) is observed when compared to the raw bentonite (line 800). However, with the coexistence of the SDS surfactant and the Fe₃O₄ micro-particles, the viscosity of the suspensions (lines 804 and 806) increases with the increased concentration of Fe₃O₄ micro-particles. The sample with the 5% Fe₃O₄ and 8 mM SDS (line 806) almost doubles the viscosity of the bentonite slurry. The inventors have found this unexpected result of increased viscosity for the novel drilling mud in spite of the increased amount of magnetic particles, which is believed to be due to a synergistic effect between the bentonite-Fe₃O₄-SDS components of this novel drilling mud.

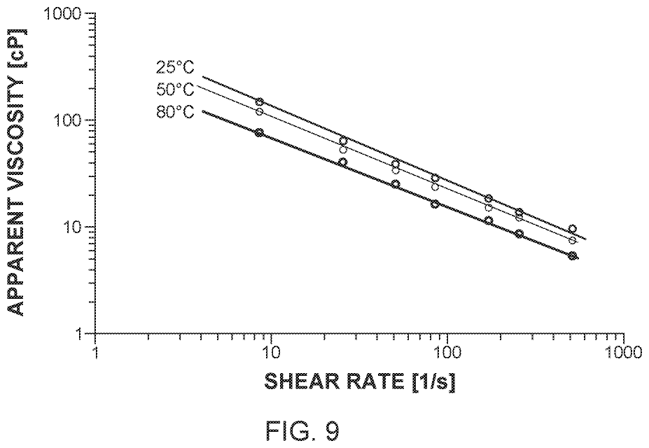

The rheological characteristics of the drilling mud are also affected by the temperature. For example, the temperature alters the rheological characteristics of a clay paste through a combination of competing effects: increased platelet Brownian motion and hindered bond formation, increased Debye-Huckel length and inter-particle repulsions, faster aggregation towards minimum potential energy configuration, and decreased fluid viscosity [4]. For example, the viscosity of water decreases from 1 cP to 0.3 cP when the temperature increases from 20° C. to 90° C. The viscosity of a drilling mud having a composition of 3% bentonite, 5% Fe₃O₄ particles, and 8 mM SDS decreases monotonically with an increase in the temperature as illustrated in FIG. 9.

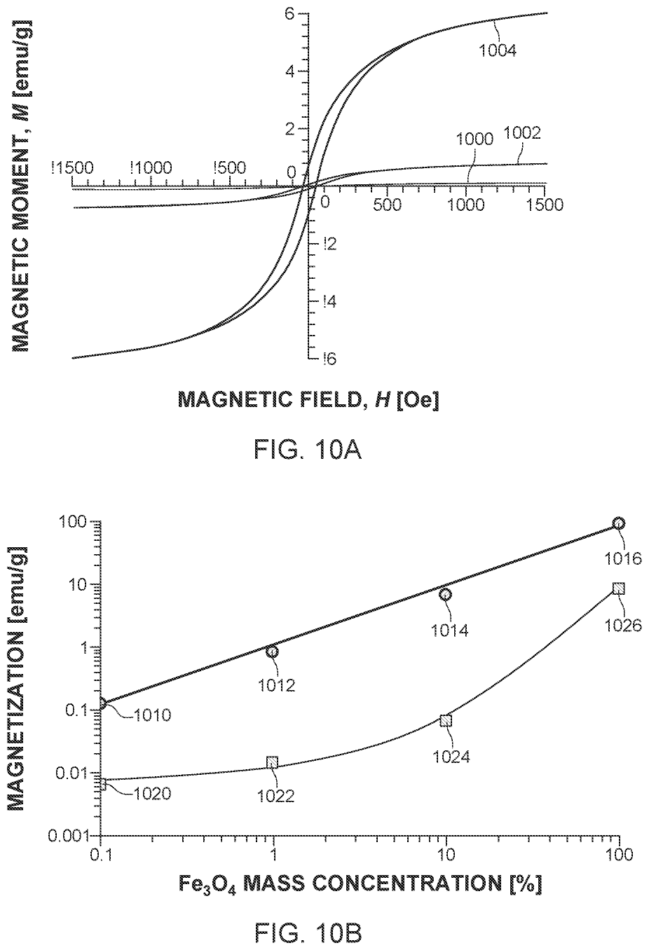

The novel magnetic drilling mud has been found to exhibit typical ferromagnetic behavior. In this regard, FIG. 10A shows the characteristic of the magnetic hysteresis loops of the magnetic drilling mud that includes micro-particles of Fe₃O₄ having a concentration of 0.1% (see curve 1000), 1% (see curve 1002), and 10% (see curve 1004). All three samples display a typical ferromagnetism behavior. The saturation magnetizations for the three compositions are found to be (at 10 kOe) 0.125 emu/g (see point 1010), 0.843 emu/g (see point 1012), and 6.656 emu/g (see point 1014) for the 0.1%, 1%, and 10% Fe₃O₄ concentrations, respectively, as shown in FIG. 10B. The residual magnetizations (at 0 Oe) for the three compositions are found to be 0.0065 emu/g (see point 1020), 0.0149 emu/g (see point 1022), and 0.0669 emu/g (see point 1024), as also illustrated in FIG. 10B. FIG. 10B also shows that the saturation magnetization for pure micro-size Fe₃O₄ powder is 95.923 emu/g (point 1016) and its residual magnetization is 8.434 emu/g (see point 1026). While the saturation magnetization is almost linearly proportional to the concentration of the Fe₃O₄ micro-particles, the residual magnetization shows a more complex relationship with the concentration of the Fe₃O₄ micro-particles.

The surface charge properties of the drilling mud have also been investigated. When an iron oxide surface comes in contact with water, a hydroxylated surface could form. The surface electrical charge of the iron oxide surface is dependent on the protonation/deprotonation of the hydroxyl groups when the pH of the solution changes. The point of zero charge (PZC) of the Fe₃O₄ micro-particles is around pH 7.9. These properties of the Fe₃O₄ micro-particles affect the interaction between the various components of the drilling mud in various ways.

For the bentonite-Tween20-Fe₃O₄ system, as a nonionic surfactant, the Tween20 is not able to interact with either the bentonite platelet or the Fe₃O₄ micro-particles, which results in the poor suspension stability of this composition.

For the bentonite-CTAB-Fe₃O₄ system, the hydrophilic head of the cationic surfactant CTAB can bind onto the negatively charged bentonite platelets and the Fe₃O₄ micro-particles via electrostatic interactions. The hydroxyl groups on the Fe₃O₄ micro-particles' surface can also form hydrogen bonds with the CTAB molecules, which likely enhanced the interaction between the Fe₃O₄ and CTAB. This seems likely to be the tail-tail interaction between the CTAB coated bentonite platelets and the Fe₃O₄ micro-particles, which contributes to the stabilization of this suspension. Also, the CTAB surfactant may serve as bridges between the bentonite and the Fe₃O₄ micro-particles

For the bentonite-SDS-Fe₃O₄ system, there are several possible interaction mechanisms between the negatively charged bentonite platelets and the anionic surfactant SDS. The ion exchange can take place between OH⁻ ions on the bentonite surfaces and the anionic part of the surfactant CH₃(CH₂)₁₁OSO₃⁻. Hydrogen bonds can form between the bentonite platelets and the surfactant molecules. In addition, it is possible that the Ca²⁺ cation establishes electrostatic bridges between the anionic part of the surfactant and the surface of the bentonite particles.

Therefore, surfactants with hydroxyl, carboxyl, sulfate, sulfonate, phosphate, phosphonate groups are expected to be capable to bond to the hydroxyl groups of the Fe₃O₄ micro-particle and subsequently modify their surface in an advantageous way for the drilling mud, as discussed above with regard to the SDS based drilling mud.

The novel SDS-based drilling mud is an economical and stable ferromagnetic drilling fluid for wellbore monitoring purpose. The micro-size iron oxide (Fe₃O₄) particles are used to magnetize the bentonite suspension and the surfactant is used to stabilize the suspension. The anionic surfactant SDS improves the stability of the suspension to the most degree among the tested surfactants (Tween 20, CTAB, and SDS). The surfactant concentration that best maintains the stability of the magnetic drilling mud is between 4˜8 mM, which is close to the CMC of the SDS.

The magnetic drilling fluid 606 exhibits a typical ferromagnetic behavior. The saturation and residual magnetizations depend on the mass concentration of Fe₃O₄ particles, as illustrated in FIG. 10B. This novel magnetic drilling fluid has a potential for use in wellbore integrity monitoring, lost circulation treatment, and water treatment.

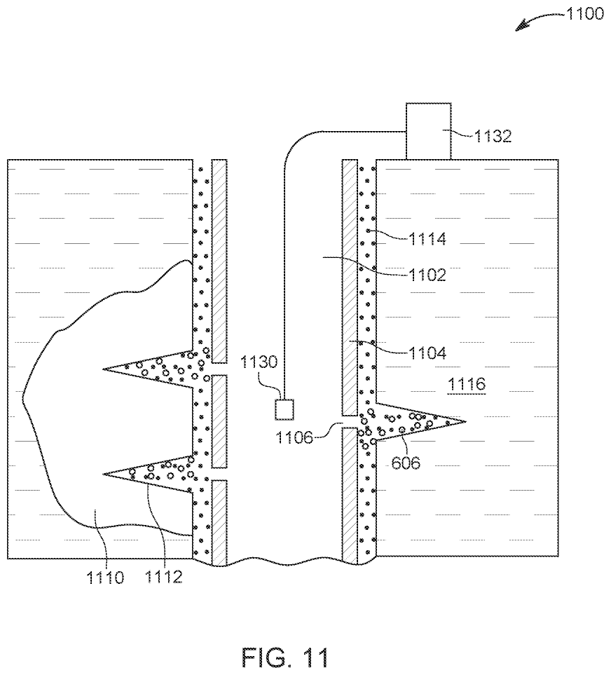

For example, as illustrated in FIG. 11, it is possible to use the novel magnetic drilling mud 606 for wellbore monitoring. In this regard, FIG. 11 shows a system 1100 that includes a well 1102 in which a non-ferromagnetic casing 1104 has been installed. In one application, the well 1102 has no casing. If the casing 1104 is present, it has plural perforations 1106 that fluidly connect the interior of the casing with the formations 1110 present around the well. One or more fractures 1112 extend from the perforations 1106 into the formations 1110. If no casing is present, the fractures 1112 are natural fractures. The annulus 1114 between the exterior of the casing 1104 and the ground 1116, at the perforations 1106, and the fractures 1112 are filed with the magnetic drilling mud 606 as shown in the figure. A magnetic probe 1130 is lowered into the well and records the magnetic field generated by the magnetic drilling mud 606. The distribution of the magnetic drilling mud 606 can be evaluated through the magnetic survey because of the high magnetic susceptibility and residual magnetization of the magnetic drilling mud, which permits a processor 1132, located at the surface, to imagine the well, the casing, the fractures, and the various formations in which the magnetic drilling mud has entered.

The same system can be used to identify the lost circulation material in the well. The magnetic drilling mud 606 is pumped down the wellbore as a lost circulation material to seal unwanted fractures. Once the magnetic drilling mud reaches a thief zone (a zone where the mud leaks out of the casing), a strong magnetic field may be applied with the magnetic probe 1130 to attract the magnetic particles from the mud at the leaking area and separate them from the suspension. The ferromagnetic particles will accumulate at the entrance of the thief zone to form a solid plug. Once formed, the solid plug will inhibit further fluid flow into the thief zone. Other applications of the novel magnetic drilling mud may be envisioned.

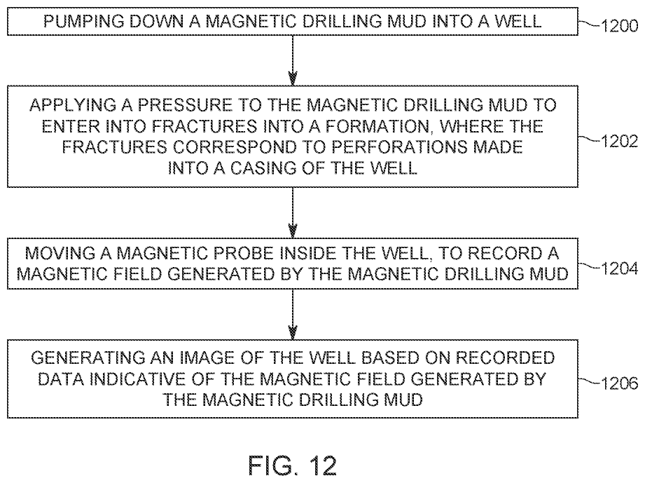

In an embodiment, illustrated in FIG. 12, there is a method for imagining a wellbore. The method includes a step 1200 of pumping down a magnetic drilling mud 606 into a well 1102, a step 1202 of applying a pressure to the magnetic drilling mud 606 to enter into fractures 1112 into a formation 1110, where the fractures are either natural fractures or they correspond to perforations 1106 made into a non-magnetic casing 1104 of the well 1102, a step 1204 of moving a magnetic probe 1130 inside the well 1102, to record a magnetic field generated by the magnetic drilling mud 606, and a step 1206 of generating an image of the well 1102 based on recorded data indicative of the magnetic field generated by the magnetic drilling mud 606. The magnetic drilling mud includes water, bentonite, magnetic micro-particles, and an anionic surfactant that prevents separation of the bentonite and the magnetic micro-particles in the water, and the magnetic micro-particles have a diameter less than 100 μm.

In one application, the anionic surfactant is sodium dodecyl sulfate (SDS). The SDS has a molar concentration between 4 and 8 mM. The magnetic micro-particles are Fe₃O₄. The Fe₃O₄ micro-particles have a diameter of 50 μm. In this application, a concentration of the Fe₃O₄ micro-particles is less than 10% of a total volume.

The disclosed embodiments provide a magnetic drilling mud that is stable. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Aderibigbe et al., 2016, “Application of magnetic nanoparticles mixed with propping agents in enhancing near-wellbore fracture detection,” Journal of Petroleum Science and Engineering. Elsevier, 141, pp. 133-143;
[2] Kenouche et al., 2014, “NMR investigation of functionalized magnetic nanoparticles Fe₃O₄ as T1-T2 contrast agents,” Powder Technology. Elsevier, 255, pp. 60-65;
[3] An et al., 2017, “Estimating spatial distribution of natural fractures by changing NMR T2 relaxation with magnetic nanoparticles,” Journal of Petroleum Science and Engineering. Elsevier, 157, pp. 273-287; and
[4] Liu and Santamarina, 2018, “Mudcake growth: Model and implications,” Journal of Petroleum Science and Engineering, 162, 251-259.

1. A magnetic drilling mud for use in a well, the magnetic drilling mud comprising:
water;
bentonite;
magnetic micro-particles; and
an anionic surfactant that prevents separation of the bentonite and the magnetic micro-particles in the water,
wherein the magnetic micro-particles have a diameter less than 100 μm.

2. The magnetic drilling mud of claim 1, wherein the anionic surfactant has a molecular concentration smaller than or equal to a critical micelle concentration of the anionic surfactant.

3. The magnetic drilling mud of claim 1, wherein the anionic surfactant is sodium dodecyl sulfate (SDS).

4. The magnetic drilling mud of claim 3, wherein the SDS has a molar concentration between 4 and 8 mM.

5. The magnetic drilling mud of claim 4, wherein the magnetic micro-particles are Fe₃O₄.

6. The magnetic drilling mud of claim 5, wherein the Fe₃O₄ micro-particles have a diameter of 50 μm.

7. The magnetic drilling mud of claim 6, wherein a concentration of the Fe₃O₄ micro-particles is less than 10% of a total volume of the magnetic drilling mud.

8. A method for making a magnetic drilling mud for use in a well, the method comprising:
adding bentonite to water to obtain a mixture;
aging the mixture by exposing the mixture to a temperature larger than a room temperature;
adding magnetic micro-particles to the mixture; and
adding an anionic surfactant that prevents separation of the bentonite and the magnetic micro-particles in the water,
wherein the magnetic micro-particles have a diameter less than 100 μm, and
wherein the anionic surfactant has a molecular concentration smaller than or equal to a critical micelle concentration of the anionic surfactant.

9. The method of claim 8, wherein the anionic surfactant is sodium dodecyl sulfate (SDS).

10. The method of claim 9, wherein the SDS has a molar concentration between 4 and 8 mM.

11. The method of claim 10, wherein the magnetic micro-particles are Fe₃O₄.

12. The method of claim 11, wherein the Fe₃O₄ micro-particles have a diameter of 50 μm.

13. The method of claim 12, wherein a concentration of the Fe₃O₄ micro-particles is less than 10% of a total volume of the magnetic drilling mud.

14. The method of claim 8, wherein the temperature is 85 degrees Celsius.

15. A method for imagining a wellbore, the method comprising:
pumping down a magnetic drilling mud into a well;
applying a pressure to the magnetic drilling mud to enter into fractures into a formation;
moving a magnetic probe inside the well, to record a magnetic field generated by the magnetic drilling mud; and
generating an image of the well based on recorded data indicative of the magnetic field generated by the magnetic drilling mud,
wherein the magnetic drilling mud includes water, bentonite, magnetic micro-particles, and an anionic surfactant that prevents separation of the bentonite and the magnetic micro-particles in the water, and
wherein the magnetic micro-particles have a diameter less than 100 μm.

16. The method of claim 15, wherein the anionic surfactant is sodium dodecyl sulfate (SDS) and the SDS has a molecular concentration smaller than or equal to a critical micelle concentration of the SDS.

17. The method of claim 16, wherein the SDS has a molar concentration between 4 and 8 mM.

18. The method of claim 17, wherein the magnetic micro-particles are Fe₃O₄.

19. The method of claim 18, wherein the Fe₃O₄ micro-particles have a diameter of 50 μm.

20. The method of claim 19, wherein a concentration of the Fe₃O₄ micro-particles is less than 10% of a total volume.
